(19) United States
(12) Patent Application Publication
(10) Pub. No.: US 2025/0245537 A1
(43) Pub. Date: Jul. 31, 2025

(54) RE-ENGINEERING DATA TO ENABLE AI TO EXCEED ITS CURRENT LIMITS BY UTILIZING QUANTUM ENGINEERING

(71) Applicant: Bank of America Corporation, Charlotte, NC (US)

(72) Inventor: Manu Kurian, Dallas, TX (US)

(21) Appl. No.: 18/427,666

(22) Filed: Jan. 30, 2024

(51) Int. Cl. G06N 10/40; H04L 9/08

(52) U.S. Cl. CPC G06N 10/40; H04L 9/0852

(57) ABSTRACT

Systems and methods may include a quantum computer to train an AI model. A qubit computer-readable medium may store instructions that are run on the quantum computer to perform the method herein. The method may include the quantum computer: receiving data; agglomerating the data as a dataset; and storing the dataset as a set of qubits in superposition states. The method may include the quantum computer: initiating training of an AI algorithm to create the AI model; transition the set of qubits from the superposition states into a dataset in a binary state; protecting the dataset in the binary state with a cryptographic key; and providing the dataset to a GPU to run the GPU using the dataset to train the AI algorithm to create the AI model. The quantum computer may create the AI model at a higher rate than a digital computer creates the AI model.

### FIELD OF TECHNOLOGY

Aspects of the disclosure relate to using a quantum computer to train an artificial intelligence (AI) algorithm to create an AI model.

### BACKGROUND OF THE DISCLOSURE

AI running on digital computers may eventually hit a limit regarding speed and accuracy. The speed and accuracy of digital computers may not advance fast enough to keep up with AI. Therefore, AI may be capped in its growth, or at least slowed in reaching its growth as a function of digital computer advances.

AI may need a directional tool to help it function as more than a library. AI may need a different computing technology that can at least keep up with the processing needs of advances in AI.

### SUMMARY OF THE DISCLOSURE

Provided are apparatus and methods for training an AI model using a quantum computer.

The method may include using the quantum computer to train the AI model. The method may include the quantum computer receiving data. A dataset may include the data as the data accumulates.

The method may include using the quantum computer to store the data as quantum bits. Quantum bits may be referred to as qubits. A dataset may comprise the data. The quantum computer may store the dataset as a set of qubits. The quantum computer may store the set of qubits in superposition states.

The method may include the quantum computer executing a qubit computer-readable medium. The computer readable medium may couple to the quantum computer. The coupling may be an electronic coupling. The qubit computer-readable medium may contain instructions stored thereon to perform the method herein.

The method may include initiating, at the quantum computer, training of an AI algorithm. The quantum computer may train the AI algorithm using the dataset. The quantum computer may use the AI algorithm to build the AI model.

The method may include using the quantum computer to transition the set of qubits from the superposition states into a binary state. Transitioning the set of qubits into the binary state may include transitioning the dataset into the binary state.

The method may include using the quantum computer to protect the dataset in the binary state with a cryptographic key. The cryptographic key may use quantum-resistant cryptography. The cryptographic key may use quantum cryptography.

The method may include using the quantum computer to provide the dataset to a graphics processing unit (GPU) to train the AI algorithm. The quantum computer may run the trained AI algorithm on the GPU to create the AI model.

The method may include using a digital computer running the GPU to train the AI algorithm to create the AI model at a reference rate.

The quantum computer running the GPU may train the AI algorithm to create the AI model at a higher rate than the reference rate.

The quantum computer running the GPU may train the AI algorithm to create the AI model at least two-times higher than the reference rate.

The quantum computer running the GPU may train the AI algorithm to create the AI model at least five-times higher than the reference rate.

The method may include the cryptographic key using quantum-resistant cryptography. The quantum-resistant cryptography may include post-quantum cryptography (PQC).

The method may include the cryptographic key using quantum cryptography. The quantum cryptography may include quantum key distribution (QKD).

The method may include the quantum computer running the AI model.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram in accordance with principles of the disclosure;

FIG. 2 shows an illustrative block diagram in accordance with principles of the disclosure;

FIG. 3 shows an illustrative block diagram in accordance with principles of the disclosure; and

FIG. 4 shows an illustrative flowchart in accordance with principles of the disclosure.

### DETAILED DESCRIPTION OF THE DISCLOSURE

Provided are apparatus and methods for training an artificial intelligence (AI) model using a quantum computer.

The system may include a quantum computer. The system may include a cryptographic key. The system may include an AI algorithm. The system may include the AI model. The system may include a dataset.

The system may include use of the quantum computer to train the AI model. The quantum computer may be configured to perform the activities herein.

The system may include receipt of data by the quantum computer. A dataset may include the data as the data accumulates.

The system may include use of the quantum computer to store the data as quantum bits. Quantum bits may be referred to as qubits. A dataset may comprise the data. The quantum computer may store the dataset as a set of qubits. The quantum computer may store the set of qubits in superposition states.

The system may include initiation, at the quantum computer, training of the AI algorithm. The quantum computer may train the AI algorithm using the dataset. The quantum computer may use the AI algorithm to build the AI model.

The system may include use of the quantum computer to transition the set of qubits from the superposition states into a binary state. Transitioning the set of qubits into the binary state may include transitioning the dataset into the binary state.

The system may include use of the quantum computer to protect the dataset in the binary state with a cryptographic key. The cryptographic key may use quantum-resistant cryptography. The cryptographic key may use quantum cryptography.

Quantum computing may store data in three states. The three states may include on, off, and on/off. The three states may include zero, one, and zero/one. The three states may include heads of a coin, tails of the coin, and spin (e.g., clockwise, or counterclockwise) of the coin.

When storing data in three states, quantum computing may be secure. The security may arise from the data always moving and not being predictable.

The quantum computer may provide directions to a system and let the system know when to convert the data from three states into two states. Two states comprise a binary state. The quantum computer may process data in the binary state more easily than in the three states. During a term of usage when the data is in the binary state, the data may be at rest and may be more vulnerable to compromise from an outside party.

The quantum computer may impose extra security measures with data in the more vulnerable binary state. Security measures may include digital security measures. Security measures may include quantum-proof security measures. When the binary data is at rest, many layers of keys may be layered upon the data to secure the data. The keys may be digital security keys. The keys may be quantum security keys.

Securing data may be more difficult when it is moving. Therefore, quantum computers may move data in the more secure three states. Quantum computers may access the more accessible binary data when the latter is at rest.

The system may include use of the quantum computer to provide the dataset to a graphics processing unit (GPU) to train the AI algorithm. The quantum computer may run the trained AI algorithm on the GPU to create the AI model.

A digital computer running the GPU may train the AI algorithm to create the AI model at a reference rate.

The quantum computer running the GPU may train the AI algorithm to create the AI model at a higher rate than the reference rate.

The quantum computer running the GPU may train the AI algorithm to create the AI model at least two-times higher than the reference rate.

The quantum computer running the GPU may train the AI algorithm to create the AI model at least five-times higher than the reference rate.

The system may include the cryptographic key using quantum-resistant cryptography. The quantum-resistant cryptography may include post-quantum cryptography (PQC).

The system may include the cryptographic key using quantum cryptography. The quantum cryptography may include quantum key distribution (QKD).

The system may include the quantum computer running the AI model.

The system may include execution of a qubit computer-readable medium on the quantum computer. The computer readable medium may couple to the quantum computer. The coupling may be an electronic coupling. The qubit computer-readable medium may contain instructions stored thereon to train the AI algorithm to create the AI model.

The system may include a quantum computer having more memory than a digital computer. The system may include a quantum computer that is faster than a digital computer. The system may include a quantum computer that trains an AI algorithm faster than a digital computer trains the AI algorithm. The system may include a quantum computer that trains an AI model faster than a digital computer trains the AI model.

An AI management system may control the quantum computer.

A quantum key may maintain data integrity and data security. The quantum key may be a directional tool. The quantum computer may process and/or store all three states of memory of a qubit at one time. The quantum computer may shard the quantum key into multiple states.

The three states of the qubit on a quantum computer may be secure as the data is always moving and not predictable. However, the quantum key may provide direction when presenting the quantum key to change the three states into two states. The three states may be superposition states. The two states may be a binary state.

The quantum computer may use the data when it is in the binary state. During this term of usage of the data in the binary state, extra security measures may be introduced. The security measures may protect the data in the binary state when the data is at rest. The security measures may protect the data in the binary state when the data is moving. The security measures may be digital computing security measures. The security measures may be quantum computing security measures.

The apparatus and methods may include the cryptographic key using quantum-resistant cryptography. The quantum-resistant cryptography may include PQC. The quantum-resistant cryptography may include a quantum-resistant cryptographic algorithm.

The quantum-resistant cryptography may ensure security of the dataset in the binary state even when faced with quantum computers that may try to compromise the security of the dataset. Quantum computers may efficiently break common current security techniques such as asymmetric encryption and digital signature algorithms based on number theory.

The quantum-resistant cryptography may include PQC that has been chosen for standardization by a standardization authority. The standardization authority may be the National Institute of Standards and Technology (NIST) in the United States. The standardization authority may be the European Union Agency for Cybersecurity (ENISA) in the European Union. The standardization authority in the European Union may include the European Committee for Standardization (CEN), the European Committee for Electrotechnical Standardization (CENELEC), and European Telecommunications Standards Institute (ETSI).

The quantum-resistant cryptography may include an algorithm referred to as cryptographic suite for algebraic lattices (CRYSTALS). The quantum-resistant cryptography may include an algorithm referred to as IND-CCA2-secure key encapsulation mechanism (KEM) that may be called Kyber. The quantum-resistant cryptography may include an algorithm that includes both CRYSTALS and Kyber. This algorithm may be referred to as CRYSTALS-Kyber. CRYSTALS-Kyber may be used for general encryption. CRYSTALS-Kyber includes a public-key encapsulation mechanism (KEM) that may be standardized to provide general encryption. General encryption may include accessing secure websites. CRYSTALS-Kyber may be based on the computational hardness of problems involving structured lattices.

Advantages of CRYSTALS-Kyber may include comparatively small encryption keys compared to other quantum-resistant algorithms. Small encryption keys may facilitate easy exchange between two parties. Another advantage may include its speed of operation.

CRYSTALS-Kyber may be used for digital signatures.

The quantum-resistant cryptography may include the CRYSTALS algorithm. The quantum-resistant cryptography may include an algorithm referred to as Dilithium. The quantum-resistant cryptography may include an algorithm that includes both CRYSTALS and Dilithium. This algorithm may be referred to as CRYSTALS-Dilithium. CRYSTALS-Dilithium may be used for digital signatures. Digital signatures may include digital signatures on electronic documents, purchase of products through the Internet, and the like. CRYSTALS-Dilithium may be based on the computational hardness of problems involving structured lattices.

Advantages of CRYSTALS-Dilithium may include a strongly secure digital signature scheme. Secure may refer to security from chosen message attacks based on the hardness of lattice problems over module lattices. CRYSTALS-Dilithium may include a higher efficiency than other quantum-resistant algorithms.

CRYSTALS-Dilithium may be used for general encryption.

The quantum-resistant cryptography may include the fast-Fourier lattice-based compact signatures over N-th degree truncated polynomial ring units (NTRU) algorithm. This may also be referred to as the FALCON algorithm. FALCON may be used for digital signatures. Digital signatures may include digital signatures on electronic documents, purchase of products through the Internet, and the like. FALCON may be based on the computational hardness of problems involving structured lattices.

Advantages of FALCON may include a strongly secure digital signature scheme. Security may result from a true Gaussian sampler that may be used internally, that may guarantee negligible leakage of information on the secret key up to a practically infinite number of signatures.

FALCON may also be compact. With the use of NTRU lattices, signatures may be substantially shorter than in any lattice-based signature scheme with the same security guarantees, while the public keys may be around the same size.

FALCON may also operate with speed. The use of fast Fourier sampling may allow for very fast implementations, such as thousands of signatures per second on a common computer, and verification may be five to ten times faster.

FALCON may also be scalable. Operations may have cost O(log n) for degree n, indicating that as input grows, the cost is not highly affected, allowing the use of very long-term security parameters at moderate cost.

FALCON may have RAM Economy. The enhanced key generation algorithm of Falcon may use less than 30 kilobytes of RAM, that may be a hundredfold improvement over previous designs such as NTRUSign. Falcon may be compatible with small, memory-constrained embedded devices.

FALCON may be used for general encryption.

The quantum-resistant cryptography may include a stateless hash-based signature scheme known as SPHINCS+. The SPHINCS+ algorithm is read as “Sphincs plus.” SPHINCS+ may be used for digital signatures. Digital signatures may include digital signatures on electronic documents, purchase of products through the Internet, and the like.

An advantage of SPHINCS+ includes that it may be an important backup to other quantum-resistant cryptographic algorithms as it is based on a different math approach than the other lead algorithms. SPHINCS+ operates using hash functions while other lead algorithms may operate with other strategies such as structured lattices.

SPHINCS+ may be used for general encryption.

The quantum-resistant cryptography may include two or more of the aforementioned, such as CRYSTALS-Dilithium, FALCON, and SPHINCS+.

Additional quantum-resistant cryptography may include Bit Flipping Key Encapsulation (BIKE), Classic McEliece, Hamming Quasi-Cyclic (HQC), Supersingular isogeny Diffie-Hellman (SIKE), and any combination thereof.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

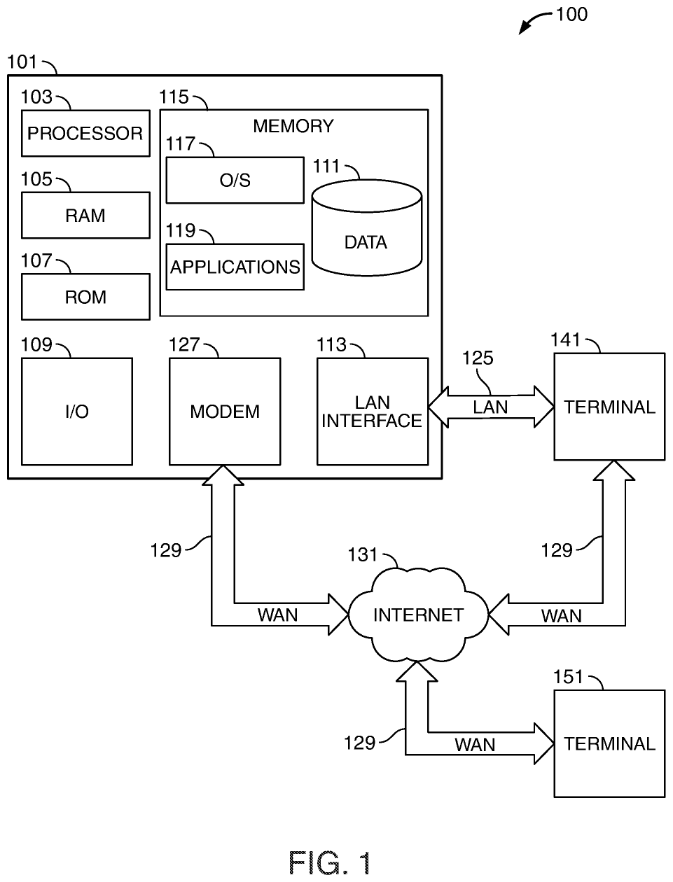

FIG. 1 shows an illustrative block diagram of apparatus 100 that includes a computer or computer system 101. Computer 101 may alternatively be referred to herein as a “computing device” or “computing system”. Computer 101 may be a quantum computer or part of a quantum computer. Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more “N”-qubit processors as well as standard microprocessors 103 for controlling the operation of the device and its associated components, and may include RAM 105, ROM 107, input/output module 109, and a memory 115. The processors 103 may also execute all software running on the computer 101—e.g., the operating system 117 and applications 119 such as a quantum authentication program and security protocols. Other components commonly used for computers, such as graphics processing unit (“GPU”), EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as a quantum authentication program and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as a quantum authentication program and security protocols) along with any data needed for the operation of the apparatus. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the processor or processors 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. These remote computers and servers, terminals 141 and 151 (as well as other terminals, not shown) may be other quantum computers. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be other quantum computers or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for a quantum authentication program and security protocols, as well as other programs. In an embodiment, one or more programs, or aspects of a program, may use one or more quantum authentication and AI/ML algorithm(s). The various tasks may be related to authenticating a user with a quantum computer.

Computer 101 may also include various other components, such as a battery (not shown), speaker (not shown), a network interface controller (not shown), and/or antennas (not shown).

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, multiprocessor systems, microprocessor-based systems, set top boxes, programmable consumer electronics, network PCs, minicomputers, mainframe computers, distributed computing environments that include any of the above systems or devices, quantum computers and the like.

Aspects of the apparatus and methods may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

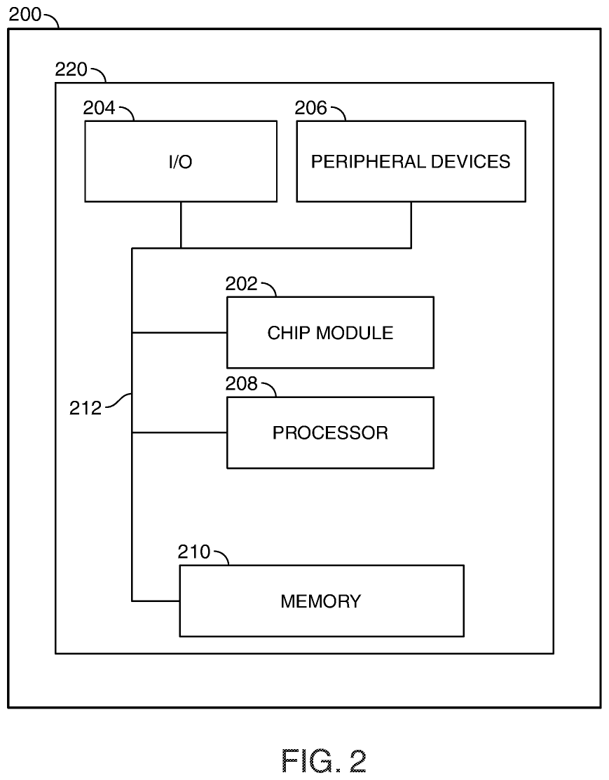

FIG. 2 shows illustrative apparatus 200 that may be configured in accordance with the principles of the disclosure. Apparatus 200 may be a quantum computer, a server, or computer with various peripheral devices 206. Apparatus 200 may include one or more features of the apparatus shown in FIGS. 1-4. Apparatus 200 may include chip module 202, which may include one or more quantum and integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may be quantum based and may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit.

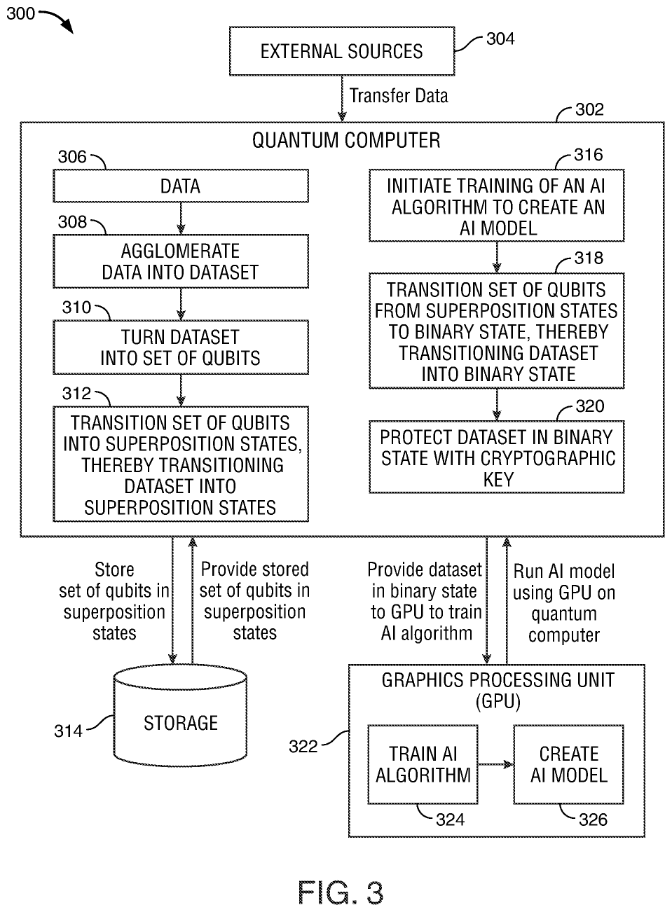

FIG. 3 shows illustrative system 300 for training an AI model using a quantum computer.

Quantum computer 302 may receive data from external sources 304. External sources 304 may include data transmitted over the internet from another party.

Quantum computer 302 may agglomerate data 306 into dataset 308. Quantum computer 302 may turn dataset 308 into set of qubits 310. Quantum computer 302 may transition set of qubits 310 into superposition states. When transitioning set of qubits 310 into superposition states, quantum computer 302 may also transition dataset 308 into superposition states 312.

Set of qubits 310 in superposition states 312 may be stored in storage 314.

Quantum computer 302 may initiate training of an AI algorithm 316 to create AI model. Quantum computer 302 may obtain from storage 314 set of qubits in superposition states 312. Quantum computer 302 may transition set of qubits in superposition states 312 to binary state, thereby transitioning the dataset into binary state 318. Quantum computer 302 may protect dataset in binary state with cryptographic key 320.

Quantum computer 302 may provide dataset in binary state to GPU 322 to train AI algorithm 324. Quantum computer 302 may run GPU 322 create AI model 326 using AI algorithm 324.

Quantum computer 302 may run AI model 326 using GPU 322.

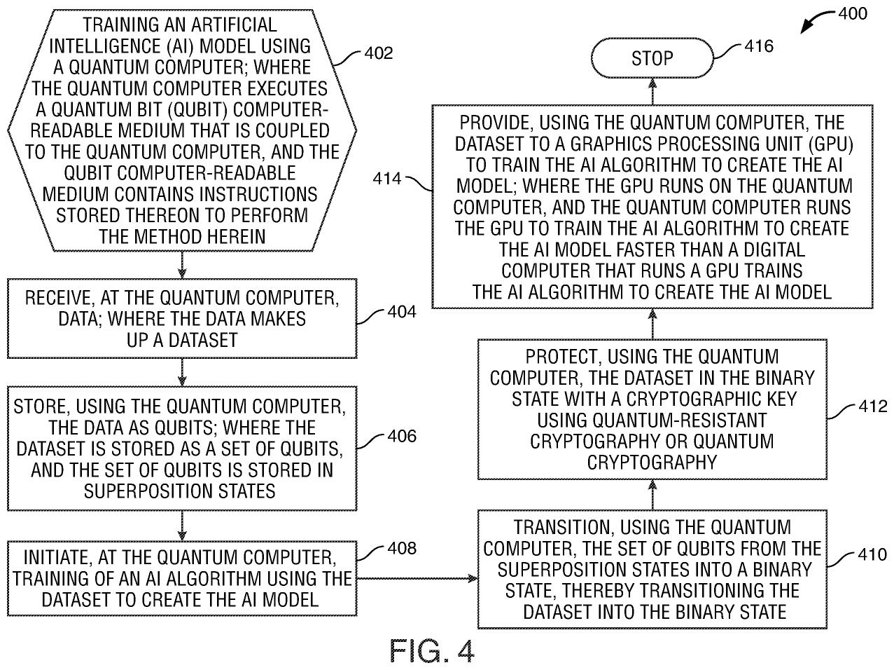

FIG. 4 shows illustrative flowchart 400 for a method of training an AI model using a quantum computer.

The flowchart may start at step 402, showing a method for training an AI model using a quantum computer. The quantum computer may execute a quantum bit (qubit) computer-readable medium that is coupled to the quantum computer. The qubit computer-readable medium may contain instructions stored thereon to perform the method herein.

At step 404, the quantum computer may receive data. The data may make up a dataset.

At step 406, the quantum computer may store the data as qubits. The quantum computer may store the dataset as a set of qubits. The quantum computer may store the set of qubits in superposition states.

At step 408, the quantum computer may initiate training of an AI algorithm. The training may use the dataset to create the AI model.

At step 410, the quantum computer may transition the set of qubits from the superposition states into a binary state. Transitioning the set of qubits into the binary state may transition the dataset into the binary state.

At step 412, the quantum computer may protect the dataset in the binary state with a with a cryptographic key. The cryptographic key may include using quantum-resistant cryptography. The cryptographic key may include using quantum cryptography.

At step 414, the quantum computer may provide the dataset to a GPU to train the AI algorithm to create the AI model. The GPU may run on the quantum computer. The quantum computer running the GPU may train the AI algorithm to create the AI model faster than a digital computer running a GPU trains the AI algorithm that creates the AI model.

At step 416, the method may stop.

Thus, provided may be systems and methods for using a quantum computer to train an AI algorithm to create an AI model. Persons skilled in the art will appreciate that the present invention can be practiced by other than the described embodiments, which are presented for purposes of illustration rather than of limitation. The present invention is limited only by the claims that follow.

What is claimed is:

1. A system for training an artificial intelligence (AI) model using a quantum computer,
the system comprising:
the quantum computer;
a cryptographic key;
an AI algorithm;
the AI model; and
a dataset that includes data;
wherein:
the quantum computer is configured to:
receive, at the quantum computer, the data;
store:
the data as quantum bits (“qubits”); and
the dataset as a set of qubits in superposition states;
initiate training of the AI algorithm using the dataset to create the AI model;
transition the set of qubits from the superposition states into a binary state, thereby transitioning the dataset into a binary state;
protect the dataset in the binary state with the cryptographic key, the cryptographic key configured to apply quantum-resistant cryptography or quantum cryptography; and
provide the dataset to a graphics processing unit (“GPU”) to train the AI algorithm to create the AI model, said GPU configured to run on the quantum computer;
wherein:
a digital computer running the GPU trains the AI algorithm to create the AI model at a reference rate; and
the quantum computer running the GPU trains the AI algorithm to create the AI model at a quantum computing rate that is higher than the reference rate.

2. The system of claim 1 wherein the quantum computing rate that is at least two-times higher than the reference rate.

3. The system of claim 1 wherein the quantum computing rate that is at least five-times higher than the reference rate.

4. The system of claim 1 wherein:
the cryptographic key is configured to use quantum-resistant cryptography; and
said quantum-resistant cryptography comprising post-quantum cryptography (PQC).

5. The system of claim 1 wherein:
the cryptographic key is configured to use quantum cryptography; and
said quantum cryptography comprising quantum key distribution (QKD).

6. The system of claim 1 wherein the quantum computer is configured to run the AI model.

7. A method for training an artificial intelligence (AI) model using a quantum computer, the method comprising:
receiving, at the quantum computer, data;
storing, using the quantum computer, the data as quantum bits;
wherein:
the quantum bits are referred to as qubits;
a dataset comprises the data;
the dataset is stored as a set of qubits;
the set of qubits is stored in superposition states; and
said quantum computer executes a qubit computer-readable medium that is coupled to the quantum computer, said qubit computer-readable medium containing instructions stored thereon to perform the method herein;
initiating, at the quantum computer, training of an AI algorithm using the dataset to create the AI model;
transitioning, using the quantum computer, the set of qubits from the superposition states into a binary state, thereby transitioning the dataset into the binary state;
protecting, using the quantum computer, the dataset in the binary state with a cryptographic key, said cryptographic key using quantum-resistant cryptography or quantum cryptography; and
providing, using the quantum computer, the dataset to a graphics processing unit (GPU) to train the AI algorithm to create the AI model, said GPU run on the quantum computer;
wherein:
a digital computer running the GPU trains the AI algorithm to create the AI model at a reference rate; and
the quantum computer running the GPU trains the AI algorithm to create the AI model at a quantum computing rate that is higher than the reference rate.

8. The method of claim 7 wherein the quantum computing rate is at least two-times higher than the reference rate.

9. The method of claim 7 wherein the quantum computer trains the AI algorithm to create the AI model at a speed that is at least five-times higher than a digital computer trains the AI algorithm to create the AI model.

10. The method of claim 7 wherein:
the cryptographic key uses quantum-resistant cryptography; and
said quantum-resistant cryptography comprising post-quantum cryptography (PQC).

11. The method of claim 7 wherein:
the cryptographic key uses quantum cryptography; and
said quantum cryptography comprising quantum key distribution (QKD).

12. The method of claim 7 wherein the quantum computer runs the AI model.

13. A quantum computing system for training an artificial intelligence (AI) model using a quantum computer, the quantum computing system comprising:
the quantum computer;
a cryptographic key;
an AI algorithm;
the AI model;
a dataset that includes data;
a quantum bit (“qubit”) computer-readable medium, coupled with the quantum computer, having instructions stored thereon, that, when executed by the quantum computer, cause the quantum computing system to perform a method comprising:
receiving, at the quantum computer, the data;
storing:
the data as quantum bits;
the dataset as a set of qubits in superposition states;
initiating training of the AI algorithm using the dataset to create the AI model;
transitioning, using the quantum computer, the set of qubits from the superposition states into a binary state, thereby transitioning the dataset into a binary state;
protecting the dataset in the binary state with the cryptographic key, said cryptographic key using quantum-resistant cryptography or quantum cryptography; and
providing, using the quantum computer, the dataset to a graphics processing unit (“GPU”) to train the AI algorithm to create the AI model, said GPU run on the quantum computer;
wherein:
a digital computer running the GPU trains the AI algorithm to create the AI model at a reference rate; and
the quantum computer running the GPU trains the AI algorithm to create the AI model at a quantum computing rate that is higher than the reference rate.

14. The quantum computing system of claim 13 wherein the quantum computing rate is at least two-times higher than the reference rate.

15. The quantum computing system of claim 13 wherein the quantum computing rate is at least five-times higher than the reference rate.

16. The quantum computing system of claim 13 wherein:
the cryptographic key uses quantum-resistant cryptography; and
said quantum-resistant cryptography comprising post-quantum cryptography (PQC).

17. The quantum computing system of claim 13 wherein:
the cryptographic key uses quantum cryptography; and
said quantum cryptography comprising quantum key distribution (QKD).

18. The quantum computing system of claim 13 wherein the quantum computer runs the AI model.
